(19) United States
(12) Patent Application Publication
(10) Pub. No.: US 2021/0127160 A1
(43) Pub. Date: Apr. 29, 2021

(54) VIDEO CONTENT CONTROL SYSTEM, METHOD AND PROGRAM

(71) Applicant: NEC Corporation, Tokyo (JP)

(72) Inventor: Satoki ABE, Minato-ku (JP)

(73) Assignee: NEC Corporation, Tokyo (JP)

(21) Appl. No.: 16/497,921

(22) PCT Filed: Feb. 8, 2018
(86) PCT No.: PCT/JP2018/004318

§ 371 Date: Sep. 26, 2019

(30) Foreign Application Priority Data
Mar. 28, 2017 (JP) 2017-062115

(51) Int. Cl. H04N 21/4415; G06K 9/00; G06F 3/01

(52) U.S. Cl. CPC H04N 21/4415; G06F 3/013; G06K 9/00288

(57) ABSTRACT

A detection result transmission unit 93 transmits the detected eyeline state and the authentication result of a user to a video management device 80. A transmission mode selection unit 81 selects a transmission mode of video content according to the received eyeline state and authentication result. When the user is authenticated and the eyeline state is a state of not looking at the video content displayed on a user terminal 90, the transmission mode selection unit 81 selects the transmission mode of transmitting the video content so as to suppress the data volume. A video content transmission unit 82 transmits the video content to the user terminal 90 according to the selected transmission mode.

### TECHNICAL FIELD

The present invention relates to a video content control system, a video management device, a user terminal, a video content receiving method and a video content control program for controlling video content to be reproduced.

### BACKGROUND ART

In recent years, as mobile networks speed up, many large video data have started to emerge. Therefore, in the future, there is a possibility that many network resources are used for video traffic in the fifth generation mobile communication system networks. Especially for mobile virtual network operators (MVNO), this can be said to be a realistic problem since the restrictions on the network resources are severe.

Generally, in the mobile network environment of the Third Generation Partnership Project (3GPP) and the like, when a request for video content is made from a user terminal, the core network side cannot determine whether or not the user is looking at the video content with the terminal. Therefore, the core network side transmits the video data just as requested.

Meanwhile, it is generally known a method of receiving only audio data of video content by a user himself/herself manipulating a terminal. However, switching between the video data and the audio data is troublesome because the terminal needs to be manipulated, and the switching is difficult under the environment where the manipulation of the terminal is limited, such as during driving. At the same time, it is generally known a method of authenticating a password by a user himself/herself manipulating a terminal as a method of preventing viewing of video content by unauthorized use. However, this is also difficult under the environment where the manipulation of the terminal is limited.

For example, Patent Literature 1 describes a videophone device that controls consumption of a network bandwidth. The videophone device described in Patent Literature 1 detects the visual line information on the communications partner from the received picture and controls the bit rate of the picture transmitted to the communication partner from the detected visual line information.

Patent Literature 2 describes a terminal device capable of activating an application desired by a user without user manipulation. The terminal device described in Patent Literature 2 collates the face image of the user with the registered image, which is a face image of an authorized user, and detects the visual line of the user from the face image of the user. Then, when the collation between the face image of the user and the registered image matches except for the visual line, the terminal device determines that the authentication of the user is successful, and activates an application according to the direction of the visual line of the user.

Moreover, Patent Literature 3 describes a picture display device that performs reduction control of power consumption. The picture control device described in Patent Literature 3 determines whether or not a user is gazing at a display screen, and switches between normal mode processing and power saving mode processing for light intensity control processing of a display unit or reproduction processing of an output unit based on the determination result.

### CITATION LIST

### Patent Literature

PTL 1: Japanese Patent Application Laid-Open No. 2013-046319

PTL 2: Japanese Patent Application Laid-Open No. 2014-071476

PTL 3: Japanese Patent Application Laid-Open No. 2010-271339

### SUMMARY OF INVENTION

### Technical Problem

The method described in Patent Literature 1 controls the consumption of the network bandwidth by reducing the data volume transmitted from the viewer side to the partner side. However, the large video content is data transmitted from the partner side. Therefore, it is difficult to control the data volume transmitted from the partner side by using the method described in Patent Literature 1.

Moreover, the method described in Patent Literature 2 authenticates the user based on the face image of the user other than the visual line. By using the method described in Patent Literature 2, it is possible to activate an application without the manipulation, but it is impossible to control the communication volume on the networks.

Furthermore, the picture display device described in Patent Literature 3 can also reduce the light intensity and the output without the explicit manipulation of the user. However, similarly to the method described in Patent Literature 2, such processing alone cannot reduce the communication volume on the networks.

Therefore, an object of the present invention is to provide a video content control system, a video management device, a user terminal, a video content receiving method and a video content control program, which are capable of performing control so as to reduce the communication volume of the networks through which the video content is transmitted, without the explicit manipulation of the user.

### Solution to Problem

A video content control system according to the present invention includes: a video management device that manages video content distributed from a server; and a user terminal that displays the video content transmitted from the video management device, in which the user terminal includes: a detection unit that detects an eyeline state and a face image of a user; a user authentication unit that performs authentication of the user from the face image detected; and a detection result transmission unit that transmits the eyeline state detected and a result of the authentication to the video management device, the video management device includes: a transmission mode selection unit that selects a transmission mode of the video content according to the eyeline state and the result of the authentication received; and a video content transmission unit that transmits the video content to the user terminal according to the transmission mode selected, and the transmission mode selection unit of the video management device selects the transmission mode of transmitting the video content so as to suppress a data volume when the user is authenticated and the eyeline state is a state of not looking at the video content displayed on the user terminal.

Another video content control system according to the present invention includes: a distribution server that distributes video content in response to a request; and a user terminal that displays the video content transmitted from the distribution server, in which the user terminal includes: a detection unit that detects an eyeline state and a face image of a user; a user authentication unit that performs authentication of the user from the face image detected; a transmission mode selection unit that selects a transmission mode of the video content by the distribution server according to the eyeline state and a result of the authentication; and a distribution request unit that requests the distribution server to transmit the video content in the transmission mode, the distribution server includes: a video content transmission unit that transmits the video content to the user terminal in the transmission mode according to the request from the user terminal, and the transmission mode selection unit of the user terminal selects the transmission mode of transmitting the video content so as to suppress a data volume.

A video management device according to the present invention is a video management device that manages video content distributed from a server and includes: a transmission mode selection unit that receives a result of authentication by a face image detected for a user and an eyeline state of the user from a user terminal that displays the video content transmitted from the video management device, and selects a transmission mode of the video content according to the eyeline state and the result of the authentication received; and a video content transmission unit that transmits the video content to the user terminal according to the transmission mode selected, in which the transmission mode selection unit selects the transmission mode of transmitting the video content so as to suppress a data volume when the user is authenticated and the eyeline state is a state of not looking at the video content displayed on the user terminal.

A user terminal according to the present invention is a user terminal that displays video content transmitted from a distribution server and includes: a detection unit that detects an eyeline state and a face image of a user; a user authentication unit that performs authentication of the user from the face image detected; a transmission mode selection unit that selects a transmission mode of the video content by the distribution server according to the eyeline state and a result of the authentication; and a distribution request unit that requests the distribution server to transmit the video content in the transmission mode, in which the transmission mode selection unit selects the transmission mode of transmitting the video content so as to suppress a data volume.

A video content receiving method according to the present invention is a video content receiving method of displaying video content transmitted from a distribution server and includes: detecting an eyeline state and a face image of a user; performing authentication of the user from the face image detected; selecting a transmission mode of the video content by the distribution server according to the eyeline state and a result of the authentication; requesting the distribution server to transmit the video content in the transmission mode; and selecting the transmission mode of transmitting the video content so as to suppress a data volume when the transmission mode is selected.

A video content control program according to the present invention is a video content control program applied to a computer that displays video content transmitted from a distribution server, and causes the computer to: execute detection processing of detecting an eyeline state and a face image of a user; execute user authentication processing of performing authentication of the user from the face image detected; execute transmission mode selection processing of selecting a transmission mode of the video content by the distribution server according to the eyeline state and a result of the authentication; execute distribution request processing of requesting the distribution server to transmit the video content in the transmission mode; and select, in the transmission mode selection processing, the transmission mode of transmitting the video content so as to suppress a data volume.

### Advantageous Effects of Invention

According to the present invention, it is possible to perform control so as to reduce the communication volume of the networks through which the video content is transmitted, without the explicit manipulation of the user.

### BRIEF DESCRIPTION OF DRAWINGS

FIG. 1 It depicts a block diagram illustrating a configuration example of a first exemplary embodiment of a video content control system according to the present invention.

FIG. 2 It depicts a flowchart illustrating an operation example of the video content control system of the first exemplary embodiment.

FIG. 3 It depicts a block diagram illustrating a configuration example of a second exemplary embodiment of the video content control system according to the present invention.

FIG. 4 It depicts a flowchart illustrating an operation example of the video content control system of the second exemplary embodiment.

FIG. 5 It depicts a block diagram illustrating an overview of the video content control system according to the present invention.

FIG. 6 It depicts a block diagram illustrating another overview of the video content control system according to the present invention.

FIG. 7 It depicts a block diagram illustrating an overview of the video management device according to the present invention.

FIG. 8 It depicts a block diagram illustrating an overview of a user terminal according to the present invention.

### DESCRIPTION OF EMBODIMENTS

Hereinafter, exemplary embodiments of the present invention will be described with reference to the drawings. Note that in the following description, video content includes not only data on a picture including audio but also data on only audio. Moreover, in a case of distinguishing the picture from the audio in the transmitted video content, the transmitted picture is referred to as a picture stream, and the transmitted audio is referred to as an audio stream.

Furthermore, selecting the state of the video content is referred to as stream selection in some cases. The state of the distributed video content may include normal distribution, change of bit rate, data obtained by extracting only the audio, and the like.

### Exemplary Embodiment 1

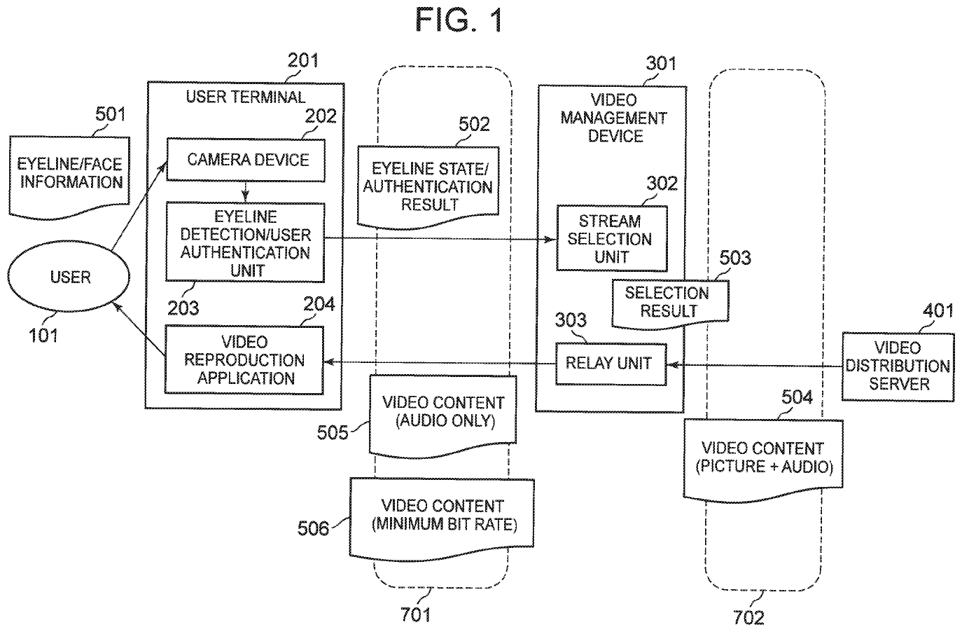

FIG. 1 depicts a block diagram illustrating a configuration example of a first exemplary embodiment of a video content control system according to the present invention. Note that the unidirectional arrows illustrated in FIG. 1 indicate the directions of the flow of certain data clearly and do not exclude bidirectionality. The video content control system of the present exemplary embodiment includes a user terminal 201, a video management device 301 and a video distribution server 401. In the first exemplary embodiment, a method of performing stream selection by the video management device 301 will be described.

The user terminal 201 and the video management device 301 are connected via a communication network 701. The communication network 701 is, for example, a 3GPP cellular network. Moreover, the video management device 301 and the video distribution server 401 are connected via a communication network 702. The communication network 702 is, for example, the Internet.

The user terminal 201 includes a camera device 202, an eyeline detection/user authentication unit 203 and a video reproduction application 204. The user terminal 201 is realized by, for example, a network device connected to the communication network 701. The user terminal 201 displays, on the screen thereof, video content transmitted from the video management device 301.

The camera device 202 is a device that acquires eyeline/face information 501 on a user 101.

The eyeline detection/user authentication unit 203 detects the eyeline state and the face image of the user. Specifically, the eyeline detection/user authentication unit 203 authenticates whether or not the user 101 is looking at the screen of the user terminal 201. Herein, the eyeline state is referred to as being valid when it has been detected that the user is looking at the screen, and the eyeline state is referred to as being invalid when it has been detected that the user is not looking at the screen.

For example, the eyeline detection/user authentication unit 203 may determine that the eyeline is valid by detecting that the eyeline of the user directs the screen of the user terminal 201 displaying the video content. The eyeline detection/user authentication unit 203 may use a general method of authenticating the eyeline.

Furthermore, the eyeline detection/user authentication unit 203 authenticates the user 101 from the detected face image. Specifically, the eyeline detection/user authentication unit 203 authenticates whether the detected face image indicates a registered user. Herein, the authentication result is referred to as being OK when the user is authenticated, and the authentication result is referred to as being NG when the user is not authenticated. Since the method of comparing the images is widely known, the detailed description thereof is omitted herein.

The eyeline detection/user authentication unit 203 transmits an eyeline state/authentication result 502 to the video management device 301.

The video reproduction application 204 reproduces the video content received from the video management device 301. Specifically, the video reproduction application 204 reproduces a picture including audio or only audio as the video content.

The video management device 301 includes a stream selection unit 302 and a relay unit 303. As illustrated in FIG. 1, the video management device 301 is positioned between the communication network 702 (the Internet) and the communication network 701 (the mobile network). The video management device 301 manages the video content distributed from the video distribution server 401.

The stream selection unit 302 receives the eyeline state/authentication result 502 from the user terminal 201. Then, the stream selection unit 302 selects a transmission mode of the video content according to the received eyeline state/authentication result 502.

At this time, when the user is not authenticated, the stream selection unit 302 decides not to transmit the video content. On the other hand, when the user is authenticated and the eyeline state is invalid (i.e., when the user 101 is in a state of not looking at the video content displayed on the user terminal 201), the stream selection unit 302 selects a transmission mode of transmitting the video content so as to suppress the data volume. Note that, when the user is authenticated and the eyeline state is valid (i.e., when the user 101 is in a state of looking at the video content displayed on the user terminal 201), the stream selection unit 302 only needs to select a normal transmission mode.

Examples of the transmission mode of changing the video content so as to suppress the data volume include a method of extracting and transmitting only an audio stream and a method of transmitting the video content at the minimum bit rate. Which type of transmission mode to select may be defined in advance, or which one to select may be decided according to the data volume. The stream selection unit 302 transmits a selection result 503 to the relay unit 303.

The relay unit 303 transmits the video content to the user terminal 201 according to the selected transmission mode. The relay unit 303 may convert the video content based on the received selection result 503. For example, when a normal picture stream is selected as the transmission mode, the relay unit 303 transmits video content 504 received from the video distribution server 401 to the user terminal 201 without conversion. Moreover, for example, when only an audio stream is selected as the transmission mode, the relay unit 303 generates video content 505 in which only the audio is extracted from the video content 504, and transmits the video content 505 to the user terminal 201. Furthermore, for example, when the minimum bit rate is selected as the transmission mode, the relay unit 303 reduces the transmission bit rate and transmits video content 506 to the user terminal 201.

Note that the minimum bit rate is exemplified as the transmission mode in the above example, but the bit rate does not have to be the minimum. The relay unit 303 may transmit the video content by reducing the bit rate to a predetermined bit rate according to the bandwidth of the communication network 701 or the like.

The stream selection unit 302 and the relay unit 303 are realized by the CPU of a computer that operates in accordance with a program (video content control program). For example, the program may be stored in a storage unit (not shown) of the video management device 301, and the CPU may read the program and operate as the stream selection unit 302 and the relay unit 303 in accordance with the program. Further, the stream selection unit 302 and the relay unit 303 may be each realized by dedicated hardware.

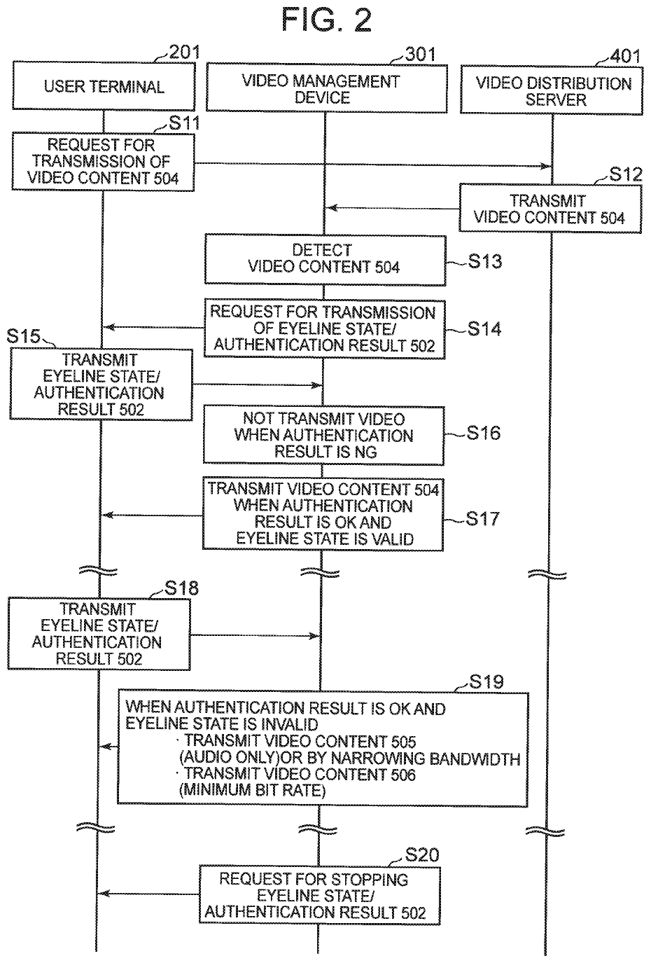

Next, the operation of the video content control system of the present exemplary embodiment will be described. FIG. 2 depicts a flowchart illustrating an operation example of the video content control system of the present exemplary embodiment.

First, the user terminal 201 requests the video distribution server 401 to transmit the video content 504 (step S11). The video distribution server 401 transmits the video content 504 to the video management device 301 (step S12). The video management device 301 detects the video content 504 (step S13). Then, the video management device 301 requests the user terminal 201 to transmit the eyeline state/authentication result 502 (step S14).

The user terminal 201 transmits the eyeline state/authentication result 502 to the video management device 301 (step S15). When the authentication result is NG, the video management device 301 does not transmit the video to the user terminal 201 (step S16). On the other hand, when the authentication result is OK and the eyeline state is valid, the video management device 301 transmits the video content 504 to the user terminal 201 (step S17).

Moreover, the user terminal 201 transmits the eyeline state/authentication result 502 to the video management device 301 (step S18). Herein, assume that the video management device 301 has received the eyeline state/authentication result 502 indicating that the authentication result is OK and the eyeline state is invalid. In this case, the video management device 301 extracts only the audio from the video content 504 and transmits the video content 505 (the audio only) to the user terminal 201. Alternatively, the video management device 301 narrows the network bandwidth between the video distribution server 401 and the video management device 301 to force the minimum bit rate for encrypted communication such as SSL/TLS and transmits the video content 506 (minimum bit rate) to the user terminal 201 (step S19).

The video management device 301 ends the video content 504 as well as requests the user terminal 201 to stop the eyeline state/authentication result 502 (step S20).

As described above, in the present exemplary embodiment, the eyeline detection/user authentication unit 203 of the user terminal 201 detects the eyeline state and face image of the user 101, performs the user authentication from the detected face image, and transmits the eyeline state and the authentication result to the video management device 301. Moreover, the stream selection unit 302 of the video management device 301 selects the transmission mode of the video content according to the received eyeline state and authentication result, and the relay unit 303 transmits the video content to the user terminal 201 according to the selected transmission mode. At this time, when the user is authenticated and the eyeline state is invalid (when the user 101 is in a state of not looking at the video content displayed on the user terminal 201), the stream selection unit 302 transmits the video content so as to suppress the data volume. With such a configuration, it is possible to perform control so as to reduce the communication volume of the networks through which the video content is transmitted, without the explicit manipulation of the user.

That is, in FIG. 1, the user terminal 201, which has detected the eyeline/face information 501 on the user 101, transmits the eyeline state/authentication result 502, which is a combination of the eyeline state and the user authentication, to the video management device 301 to perform unlock and resume the picture stream distribution simultaneously. When the user 101 is not looking at the screen, the video management device 301 extracts only the audio stream or selects the minimum bit rate. Accordingly, unauthorized use by a person other than the user 101 can be prevented without the user 101 herself/himself manipulating the user terminal 201. Furthermore, by thus suppressing the traffic, the network resources of the communication network 701 can be effectively utilized.

Further, in order to realize the video content control system of the present exemplary embodiment, it is unnecessary to modify the existing video reproduction application 204.

Note that the case where the eyeline detection/user authentication unit 203 transmits the eyeline state and the authentication result to the video management device 301 has been described in the present exemplary embodiment. Note that the eyeline detection/user authentication unit 203 may transmit the eyeline state and the authentication result to the video management device 301 when the user is authenticated. According to such a configuration, it is possible to reduce the communication volume and also the load on the video management device 301.

### Exemplary Embodiment 2

Next, a second exemplary embodiment of the video content control system according to the present invention will be described. In the first exemplary embodiment, the case where the video management device performs the stream selection has been described. In the present exemplary embodiment, a method of performing stream selection by a user terminal will be described.

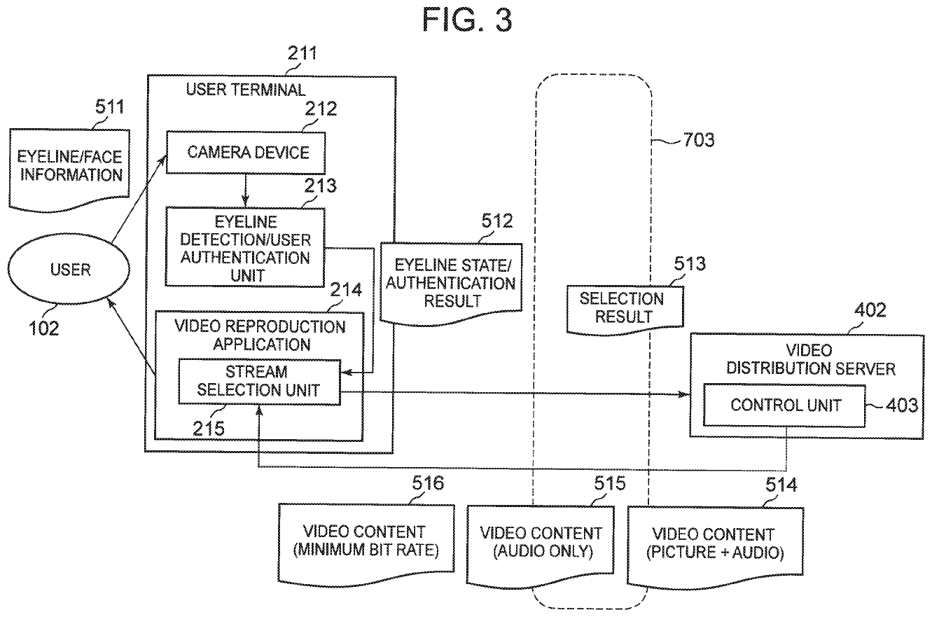

FIG. 3 depicts a block diagram illustrating a configuration example of the second exemplary embodiment of the video content control system according to the present invention. Note that the unidirectional arrows illustrated in FIG. 3 also indicate the directions of the flow of certain data clearly and do not exclude bidirectionality. The video content control system of the present exemplary embodiment includes a user terminal 211 and a video distribution server 402. The user terminal 211 and the video distribution server 402 are connected via a communication network 703.

The user terminal 211 includes a camera device 212, an eyeline detection/user authentication unit 213, a video reproduction application 214 and a stream selection unit 215. The user terminal 211 is realized by a network device connected to the communication network 703. The user terminal 211 displays, on the screen thereof, video content transmitted from the video distribution server 402.

The camera device 212 is a device that acquires eyeline/face information 511 on a user 102.

The eyeline detection/user authentication unit 213 detects the eyeline state and the face image of the user 102 and authenticates the user 102. Note that the method of detecting the eyeline state and the face image of the user as well as the method of authenticating the user 102 by the eyeline detection/user authentication unit 213 are the same as those by the eyeline detection/user authentication unit 203 in the first exemplary embodiment.

The eyeline detection/user authentication unit 213 notifies the stream selection unit 215 of an eyeline state/authentication result 512. Note that the stream selection unit 215 may be included in the video reproduction application 214 or may be separated from the video reproduction application 214.

The stream selection unit 215 selects a transmission mode of the video content by the video distribution server 402 according to the received eyeline state/authentication result 512. Note that the method of selecting the transmission mode is the same as the method of selecting the transmission mode by the stream selection unit 302 in the first exemplary embodiment. That is, the stream selection unit 215 acquires the eyeline state/authentication result 512, selects a normal picture stream when the user 102 is looking at the screen, and selects only an audio stream or the minimum bit rate when the user 102 is not looking at the screen.

Then, by transmitting a selection result 513 to the video distribution server 402, the stream selection unit 215 requests the video distribution server 402 to transmit the video content in the selected transmission mode.

The video reproduction application 214 reproduces the video content received from the video distribution server 402. Specifically, the video reproduction application 214 reproduces a picture including audio or only audio as the video content.

The eyeline detection/user authentication unit 213, the video reproduction application 214 and the stream selection unit 215 are realized by the CPU of a computer that operates in accordance with a program (video content control program). For example, the program may be stored in a storage unit (not shown) of the user terminal 211, and the CPU may read the program and operate as the eyeline detection/user authentication unit 213, the video reproduction application 214 and the stream selection unit 215 in accordance with the program.

The video distribution server 402 distributes the video content in response to a request from the user terminal 211. The video distribution server 402 includes a control unit 403.

The control unit 403 transmits the video content to the user terminal 211 in a transmission mode according to the request from the user terminal 211. For example, when a normal picture stream is requested as the transmission mode, the control unit 403 transmits video content 514 including a picture and audio to the user terminal 211 without conversion. Moreover, for example, when only an audio stream is requested as the transmission mode, the control unit 403 generates video content 515 in which only the audio is extracted from the video content, and transmits the video content 515 to the user terminal 211. Furthermore, for example, when the minimum bit rate is requested as the transmission mode, the control unit 403 reduces the transmission bit rate and transmits video content 516 to the user terminal 211.

Note that the bit rate does not have to be the minimum as described in the first exemplary embodiment. The control unit 403 may transmit the video content by reducing the bit rate to a predetermined bit rate according to the bandwidth of the communication network 703 or the like.

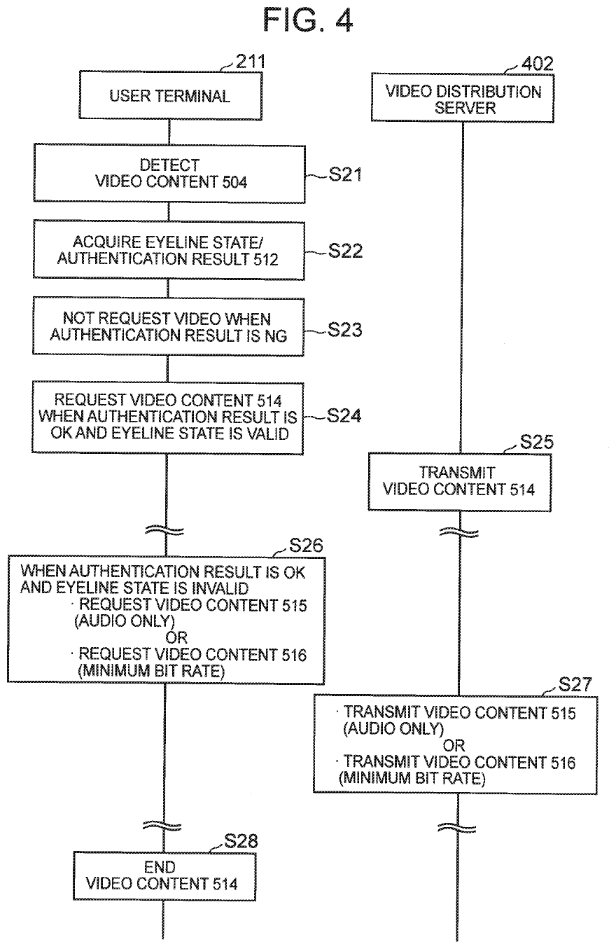

Next, the operation of the video content control system of the present exemplary embodiment will be described. FIG. 4 depicts a flowchart illustrating an operation example of the video content control system of the present exemplary embodiment.

The user terminal 211 detects the video content 514 (step S21). The user terminal 211 (more specifically, the eyeline detection/user authentication unit 213) detects the eyeline state and the face image of the user 102 and acquires the eyeline state/authentication result 512 (step S22). When the authentication result is NG, the user terminal 211 does not request the video (step S23). On the other hand, when the authentication result is OK and the eyeline state is valid, the user terminal 211 requests the video distribution server 402 for the video content 514 (step S24). The video distribution server 402 transmits the video content 514 to the user terminal 211 in response to the request (step S25).

On the other hand, when the authentication result is OK and the eyeline state is invalid, the user terminal 211 requests the video distribution server 402 for the video content 515 (audio only). Alternatively, the user terminal 211 requests the video distribution server 402 for the video content 516 (minimum bit rate) (step S26).

The video distribution server 402 transmits the video content 515 (audio only) or the video content 516 (minimum bit rate) to the user terminal 211 (step S27).

The user terminal 211 (more specifically, the eyeline detection/user authentication unit 213) ends the video content 514 as well as stops the eyeline detection/user authentication (step S28).

As described above, in the present exemplary embodiment, the eyeline detection/user authentication unit 213 of the user terminal 211 detects the eyeline state and the face image of the user 102 and authenticates the user from the detected face image. Then, the stream selection unit 215 selects the transmission mode of the video content by the video distribution server 402 according to the eyeline state and the authentication result and requests the video distribution server 402 to transmit the video content in the selected transmission mode. The control unit 403 of the video distribution server 402 transmits the video content to the user terminal 211 in the transmission mode according to the request from the user terminal 211.

With such a configuration, it is also possible to perform control so as to reduce the communication volume of the networks through which the video content is transmitted, without the explicit manipulation of the user.

That is, in FIG. 3, the user terminal 211, which has detected the eyeline/face information 511 of the user 102, generates a combination of the eyeline state and the user authentication (eyeline state/authentication result 512). Then, the user terminal 211 transmits the selection result 513 to the video distribution server 402 to perform unlock and resume the picture stream distribution simultaneously. Specifically, the stream selection unit 215 selects only the audio stream or the minimum bit rate when the user 102 is not looking at the screen. Accordingly, unauthorized use by a person other than the user 102 can be prevented without the user 102 himself/himself manipulating the user terminal 211. Furthermore, by thus suppressing the traffic, the network resources of the communication network 703 can be effectively utilized.

Further, in order to realize the video content control system of the present exemplary embodiment, it is unnecessary to install the video management device 301 illustrated in the first exemplary embodiment.

The first exemplary embodiment and the second exemplary embodiment of the video content control system according to the present invention have been described above. However, the configuration of the video content control system according to the present invention is not limited to the first exemplary embodiment or the second exemplary embodiment.

In the above exemplary embodiments, the case where there is one user who uses the user terminal has been described. However, it is also presumed that the user terminal is temporarily passed to a third person to be used. In this case, by registering the face information on the third person in the user terminal, it is possible to permit the person to view the video content by using that user terminal thereafter.

Moreover, the number of persons who views the video content at once is not limited to one and may be plural. In this case, the video content can be controlled by the eyeline detection/user authentication unit 203 or the eyeline detection/user authentication unit 213 performing the eyeline state and the user authentication for some or all the users.

Specifically, the eyeline detection/user authentication unit 203 or the eyeline detection/user authentication unit 213 may detect the eyeline states and the face images of the plurality of users. Then, the stream selection unit 302 or the stream selection unit 215 may select the transmission mode of transmitting the video content so as to suppress the data volume when some of the users are authenticated and all the eyeline states are states of not looking at the video content displayed on the user terminal. In other words, the eyeline state may be regarded as valid when the authentication result is regarded as OK in a case where at least one of the plurality of users could be authenticated and it has been detected that at least one user is looking at the screen.

Furthermore, by using the video content control system according to the present invention, it is possible to perform parental control in addition to control for the purpose of unauthorized use. For example, it is possible for a parent to prevent a child from viewing video on a user terminal and to prevent a child from viewing video without permission when the parent hands the child parent's user terminal temporarily.

In addition, the video reproduction application 204 (video reproduction application 214) may pause video viewing when the eyeline state is invalid (when the user is not looking at the screen). For example, when a business operator transmits a time-limited video format advertisement to the user terminal, the video reproduction application may pause the advertisement when the user is not looking at the screen and resume the advertisement when the user is looking at the screen in order to ensure that the advertisement is viewed. In this way, it is possible to ensure that the user views the advertisement.

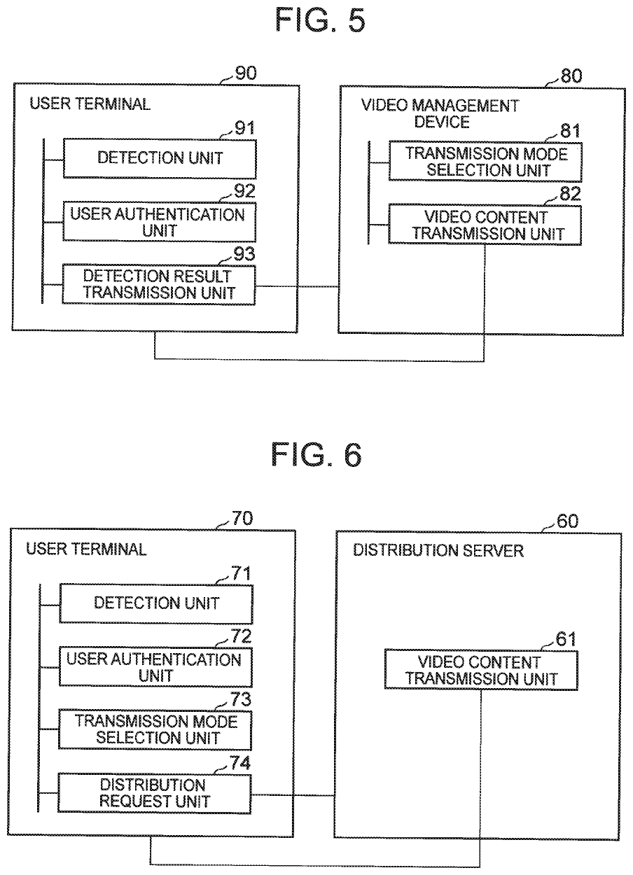

Next, an overview of the present invention will be described. FIG. 5 depicts a block diagram illustrating an overview of the video content control system according to the present invention. The video content control system according to the present invention includes a video management device 80 (e.g., the video management device 301) that manages video content distributed from a server (e.g., the video distribution server 401), and a user terminal 90 (e.g., the user terminal 201) that displays the video content transmitted from the video management device 80.

The user terminal 90 includes a detection unit 91 (e.g., the eyeline detection/user authentication unit 203) that detects an eyeline state and a face image of a user, a user authentication unit 92 (e.g., the eyeline detection/user authentication unit 203) that performs user authentication from the detected face image, and a detection result transmission unit 93 (e.g., the eyeline detection/user authentication unit 203) that transmits the detected eyeline state and the authentication result to the video management device 80.

The video management device 80 includes a transmission mode selection unit 81 (e.g., the stream selection unit 302) that selects a transmission mode of the video content according to the received eyeline state and authentication result, and a video content transmission unit 82 (e.g., the relay unit 303) that transmits the video content to the user terminal 90 according to the selected transmission mode.

When the user is authenticated and the eyeline state is a state of not looking at the video content displayed on the user terminal 90, the transmission mode selection unit 81 of the video management device 80 selects the transmission mode of transmitting the video content so as to suppress the data volume.

With such a configuration, it is possible to perform control so as to reduce the communication volume of the networks through which the video content is transmitted, without the explicit manipulation of the user. Moreover, since the data volume is suppressed when the user is in a state of not looking at the video content displayed on the user terminal 90, it is also possible to suppress a decrease in user satisfaction.

Furthermore, the transmission mode selection unit 81 may select transmission of only the audio of the video content (the video content 505) as the transmission mode of transmitting the video content so as to suppress the data volume. Then, the video content transmission unit 82 may extract the audio from the video content and transmit the audio to the user terminal.

Besides, the transmission mode selection unit 81 may select reduction of the bit rate for the transmission to the user terminal 90 (transmission of the video content 506) as the transmission mode of transmitting the video content so as to suppress the data volume. Then, the video content transmission unit 82 may reduce the bit rate and transmit the video content to the user terminal 90.

Further, when the user has been authenticated, the detection result transmission unit 93 may transmit the detected eyeline state and the authentication result to the video management device.

In addition, the detection unit 91 may detect eyeline states and face images of a plurality of users. Then, the transmission mode selection unit 81 may select the transmission mode of transmitting the video content so as to suppress the data volume when some of the users are authenticated and all the eyeline states are states of not looking at the video content displayed on the user terminal 90.

FIG. 6 depicts a block diagram illustrating another overview of the video content control system according to the present invention. The video content control system according to the present invention includes a distribution server 60 (e.g., the video distribution server 402) that distributes video content in response to a request, and a user terminal 70 (e.g., the user terminal 211) that displays the video content transmitted from the distribution server 60.

The user terminal 70 includes a detection unit 71 (e.g., the eyeline detection/user authentication unit 213) that detects an eyeline state and a face image of a user, a user authentication unit 72 (e.g., the eyeline detection/user authentication unit 213) that performs user authentication from the detected face image, a transmission mode selection unit 73 (e.g., the stream selection unit 215) that selects a transmission mode of the video content by the distribution server 60 according to the eyeline state and the authentication result, and a distribution request unit 74 (e.g., the stream selection unit 215) that requests the distribution server 60 to transmit the video content in the above transmission mode.

The distribution server 60 includes a video content transmission unit 61 (e.g., the control unit 403) that transmits the video content to the user terminal 70 in the transmission mode according to the request from the user terminal 70. The transmission mode selection unit 73 of the user terminal 70 selects the transmission mode of transmitting the video content so as to suppress the data volume.

With such a configuration, it is also possible to perform control so as to reduce the communication volume of the networks through which the video content is transmitted, without the explicit manipulation of the user.

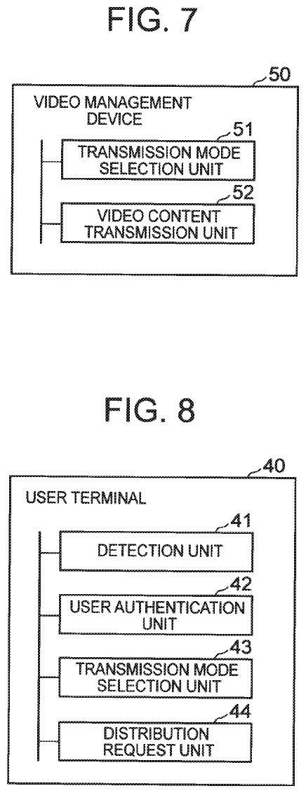

FIG. 7 depicts a block diagram illustrating an overview of the video management device according to the present invention. The video management device according to the present invention is a video management device 50 (e.g., the video management device 301) that manages video content distributed from a server (e.g., the video distribution server 401) and includes a transmission mode selection unit 51 (e.g., the stream selection unit 302) that receives an authentication result by the detected face image of user and an eyeline state of the user from a user terminal (e.g., the user terminal 201) that displays the video content transmitted from the video management device 50, and selects a transmission mode of the video content according to the received eyeline state and authentication result, and a video content transmission unit 52 (e.g., the relay unit 303) that transmits the video content to the user terminal according to the selected transmission mode.

When the user is authenticated and the eyeline state is a state of not looking at the video content displayed on the user terminal, the transmission mode selection unit 51 selects the transmission mode of transmitting the video content so as to suppress the data volume.

With such a configuration, it is also possible to perform control so as to reduce the communication volume of the networks through which the video content is transmitted, without the explicit manipulation of the user.

FIG. 8 depicts a block diagram illustrating an overview of the user terminal according to the present invention. The user terminal according to the present invention is a user terminal 40 (e.g., the user terminal 211) that displays video content transmitted from a distribution server (e.g., the video distribution server 402) and includes a detection unit 41 (e.g., the eyeline detection/user authentication unit 213) that detects an eyeline state and a face image of a user, a user authentication unit 42 (e.g., the eyeline detection/user authentication unit 213) that performs user authentication from the detected face image, a transmission mode selection unit 43 (e.g., the stream selection unit 215) that selects a transmission mode of the video content by the distribution server according to the eyeline state and the authentication result, and a distribution request unit 44 (e.g., the stream selection unit 215) that requests the distribution server to transmit the video content in the above transmission mode.

The transmission mode selection unit 43 selects the transmission mode of transmitting the video content so as to suppress the data volume.

With such a configuration, it is also possible to perform control so as to reduce the communication volume of the networks through which the video content is transmitted, without the explicit manipulation of the user.

Some or all of the above exemplary embodiments may be possibly described as in the following supplementary notes, but are not limited to the following.

### (Supplementary Note 1)

A video content control system including: a video management device that manages video content distributed from a server; and a user terminal that displays the video content transmitted from the video management device, in which the user terminal includes: a detection unit that detects an eyeline state and a face image of a user; a user authentication unit that performs authentication of the user from the face image detected; and a detection result transmission unit that transmits the eyeline state detected and a result of the authentication to the video management device, the video management device includes: a transmission mode selection unit that selects a transmission mode of the video content according to the eyeline state and the result of the authentication received; and a video content transmission unit that transmits the video content to the user terminal according to the transmission mode selected, and the transmission mode selection unit of the video management device selects the transmission mode of transmitting the video content so as to suppress a data volume when the user is authenticated and the eyeline state is a state of not looking at the video content displayed on the user terminal.

### (Supplementary Note 2)

The video content control system according to supplementary note 1, in which the transmission mode selection unit selects transmission of only audio of the video content as the transmission mode of transmitting the video content so as to suppress the data volume, and the video content transmission unit extracts the audio from the video content and transmits the audio to the user terminal.

### (Supplementary Note 3)

The video content control system according to supplementary note 1, in which the transmission mode selection unit selects reduction of a bit rate for transmission to the user terminal as the transmission mode of transmitting the video content so as to suppress the data volume, and the video content transmission unit reduces the bit rate and transmits the video content to the user terminal.

### (Supplementary Note 4)

The video content control system according to any one of supplementary notes 1 to 3, in which the detection result transmission unit transmits the eyeline state detected and the result of the authentication to the video management device when the user has been authenticated.

### (Supplementary Note 5)

The video content control system according to any one of supplementary notes 1 to 4, in which the detection unit detects eyeline states and face images of a plurality of users, and the transmission mode selection unit selects the transmission mode of transmitting the video content so as to suppress the data volume when some of the users are authenticated and all the eyeline states are states of not looking at the video content displayed on the user terminal.

### (Supplementary Note 6)

A video content control system including: a distribution server that distributes video content in response to a request; and a user terminal that displays the video content transmitted from the distribution server, in which the user terminal includes: a detection unit that detects an eyeline state and a face image of a user; a user authentication unit that performs authentication of the user from the face image detected; a transmission mode selection unit that selects a transmission mode of the video content by the distribution server according to the eyeline state and a result of the authentication; and a distribution request unit that requests the distribution server to transmit the video content in the transmission mode, the distribution server includes: a video content transmission unit that transmits the video content to the user terminal in the transmission mode according to the request from the user terminal, and the transmission mode selection unit of the user terminal selects the transmission mode of transmitting the video content so as to suppress a data volume.

### (Supplementary Note 7)

The video content control system according to supplementary note 6, in which the transmission mode selection unit selects transmission of only audio of the video content as the transmission mode of transmitting the video content so as to suppress the data volume, and the video content transmission unit extracts the audio from the video content and transmits the audio to the user terminal.

### (Supplementary Note 8)

The video content control system according to supplementary note 6, in which the transmission mode selection unit selects reduction of a bit rate for transmission to the user terminal as the transmission mode of transmitting the video content so as to suppress the data volume, and the video content transmission unit reduces the bit rate and transmits the video content to the user terminal.

### (Supplementary Note 9)

A video management device that manages video content distributed from a server, the video management device including: a transmission mode selection unit that receives a result of authentication by a face image detected for a user and an eyeline state of the user from a user terminal that displays the video content transmitted from the video management device, and selects a transmission mode of the video content according to the eyeline state and the result of the authentication received; and a video content transmission unit that transmits the video content to the user terminal according to the transmission mode selected, in which the transmission mode selection unit selects the transmission mode of transmitting the video content so as to suppress a data volume when the user is authenticated and the eyeline state is a state of not looking at the video content displayed on the user terminal.

### (Supplementary Note 10)

The video management device according to supplementary note 9, in which the transmission mode selection unit selects transmission of only audio of the video content as the transmission mode of transmitting the video content so as to suppress the data volume, and the video content transmission unit extracts the audio from the video content and transmits the audio to the user terminal.

### (Supplementary Note 11)

The video management device according to supplementary note 9, in which the transmission mode selection unit selects reduction of a bit rate for transmission to the user terminal as the transmission mode of transmitting the video content so as to suppress the data volume, and the video content transmission unit reduces the bit rate and transmits the video content to the user terminal.

### (Supplementary Note 12)

A user terminal that displays video content transmitted from a distribution server, the user terminal including: a detection unit that detects an eyeline state and a face image of a user; a user authentication unit that performs authentication of the user from the face image detected; a transmission mode selection unit that selects a transmission mode of the video content by the distribution server according to the eyeline state and a result of the authentication; and a distribution request unit that requests the distribution server to transmit the video content in the transmission mode, in which the transmission mode selection unit selects the transmission mode of transmitting the video content so as to suppress a data volume.

### (Supplementary Note 13)

The user terminal according to supplementary note 12, in which the transmission mode selection unit selects transmission of only audio of the video content as the transmission mode of transmitting the video content so as to suppress the data volume.

### (Supplementary Note 14)

The user terminal according to supplementary note 12, in which the transmission mode selection unit selects reduction of a bit rate for transmission to the user terminal as the transmission mode of transmitting the video content so as to suppress the data volume.

(Supplementary note 15)

A video content control method including: detecting an eyeline state and a face image of a user by a user terminal that displays video content; performing authentication of the user by the user terminal from the face image detected; transmitting, by the user terminal, the eyeline state detected and a result of the authentication to a video management device that transmits the video content distributed from a server to the user terminal; selecting a transmission mode of the video content by the video management device according to the eyeline state and the result of the authentication received from the user terminal; transmitting the video content to the user terminal by the video management device according to the transmission mode selected; and selecting the transmission mode of transmitting the video content by the video management device so as to suppress a data volume in a case where the user is authenticated and the eyeline state is a state of not looking at the video content displayed on the user terminal when the transmission mode is selected.

### (Supplementary Note 16)

The video content control method according to supplementary note 15, in which the video management device selects transmission of only audio of the video content as the transmission mode of transmitting the video content so as to suppress the data volume, and the video management device extracts the audio from the video content and transmits the audio to the user terminal.

### (Supplementary Note 17)

The video content control method according to supplementary note 15, in which the video management device selects reduction of a bit rate for transmission to the user terminal as the transmission mode of transmitting the video content so as to suppress the data volume, and the video management device reduces the bit rate and transmits the video content to the user terminal.

### (Supplementary Note 18)

A video content control method including: detecting an eyeline state and a face image of a user by a user terminal that displays video content; performing authentication of the user by the user terminal from the face image detected; selecting, by the user terminal, a transmission mode of the video content by a distribution server that distributes the video content in response a request, according to the eyeline state and a result of the authentication; requesting, by the user terminal, the distribution server to transmit the video content in the transmission mode; transmitting, by the distribution server, the video content to the user terminal in the transmission mode according to the request from the user terminal; and selecting, by the user terminal, the transmission mode of transmitting the video content so as to suppress a data volume when the transmission mode is selected.

### (Supplementary Note 19)

The video content control method according to supplementary note 18, in which the user terminal selects transmission of only audio of the video content as the transmission mode of transmitting the video content so as to suppress the data volume, and the distribution server extracts the audio from the video content and transmits the audio to the user terminal.

### (Supplementary Note 20)

The video content control method according to supplementary note 18, in which the user terminal selects reduction of a bit rate for transmission to the user terminal as the transmission mode of transmitting the video content so as to suppress the data volume, and the distribution server reduces the bit rate and transmits the video content to the user terminal.

### (Supplementary Note 21)

A video management method of managing video content distributed from a server, the video management method including: receiving a result of authentication by a face image detected for a user and an eyeline state of the user from a user terminal that displays the video content transmitted from a video management device; selecting a transmission mode of the video content according to the eyeline state and the result of the authentication received; transmitting the video content to the user terminal according to the transmission mode selected; and

selecting the transmission mode of transmitting the video content so as to suppress a data volume in a case where the user is authenticated and the eyeline state is a state of not looking at the video content displayed on the user terminal when the transmission mode is selected.

### (Supplementary Note 22)

The video management method according to supplementary note 21, including:

selecting transmission of only audio of the video content as the transmission mode of transmitting the video content so as to suppress the data volume; and

extracting the audio from the video content and transmitting the audio to the user terminal.

### (Supplementary Note 23)

The video management method according to supplementary note 21, including:

selecting reduction of a bit rate for transmission to the user terminal as the transmission mode of transmitting the video content so as to suppress the data volume; and

reducing the bit rate and transmitting the video content to the user terminal.

### (Supplementary Note 24)

A video content receiving method of receiving and displaying video content transmitted from a distribution server, the video content receiving method including: detecting an eyeline state and a face image of a user; performing authentication of the user from the face image detected; selecting a transmission mode of the video content by the distribution server according to the eyeline state and a result of the authentication; requesting the distribution server to transmit the video content in the transmission mode; and selecting the transmission mode of transmitting the video content so as to suppress a data volume when the transmission mode is selected.

### (Supplementary Note 25)

The video content receiving method according to supplementary note 24, including selecting transmission of only audio of the video content as the transmission mode of transmitting the video content so as to suppress the data volume.

### (Supplementary Note 26)

The video content receiving method according to supplementary note 24, in which reduction of a bit rate for transmission to the user terminal is selected as the transmission mode of transmitting the video content so as to suppress the data volume.

### (Supplementary Note 27)

A video content control program applied to a computer that manages video content distributed from a server, the video content control program causing the computer to: execute transmission mode selection processing of receiving a result of authentication by a face image detected for a user and an eyeline state of the user from a user terminal that displays the video content transmitted from the computer and selecting a transmission mode of the video content according to the eyeline state and the result of the authentication received; execute video content transmission processing of transmitting the video content to the user terminal according to the transmission mode selected; and select the transmission mode of transmitting the video content so as to suppress a data volume when the user is authenticated and the eyeline state is a state of not looking at the video content displayed on the user terminal in the transmission mode selection processing.

### (Supplementary Note 28)

The video content control program according to supplementary note 27, in which the video content control program causes the computer to: select, in the transmission mode selection processing, transmission of only audio of the video content as the transmission mode of transmitting the video content so as to suppress the data volume; and extract the audio from the video content and transmit the audio to the user terminal in the video content transmission processing.

### (Supplementary Note 29)

The video content control program according to supplementary note 27, in which the video content control program causes the computer to: select, in the transmission mode selection processing, reduction of a bit rate for transmission to the user terminal as the transmission mode of transmitting the video content so as to suppress the data volume; and reduce the bit rate and transmit the video content to the user terminal in the video content transmission processing.

### (Supplementary Note 30)

A video content control program applied to a computer that displays video content transmitted from a distribution server, the video content control program causing the computer to: execute detection processing of detecting an eyeline state and a face image of a user; execute user authentication processing of performing authentication of the user from the face image detected; execute transmission mode selection processing of selecting a transmission mode of the video content by the distribution server according to the eyeline state and a result of the authentication; execute distribution request processing of requesting the distribution server to transmit the video content in the transmission mode; and select, in the transmission mode selection processing, the transmission mode of transmitting the video content so as to suppress a data volume.

### (Supplementary Note 31)

The video content control program according to supplementary note 30, in which the video content control program causes the computer to: select, in the transmission mode selection processing, transmission of only audio of the video content as the transmission mode of transmitting the video content so as to suppress the data volume.

### (Supplementary Note 32)

The video content control program according to supplementary note 30, in which the video content control program causes the computer to: select, in the transmission mode selection processing, reduction of a bit rate for transmission to the user terminal as the transmission mode of transmitting the video content so as to suppress the data volume.

### INDUSTRIAL APPLICABILITY

The present invention is suitably applied to a video content control system that controls video content to be reproduced. Moreover, the present invention is also suitably applied to mobile communication by a network device including a camera.

The present invention of this application has been described above with the exemplary embodiments and the examples, but the present invention of this application is not limited to the above exemplary embodiments or the examples. The configurations and details of the present invention of this application can be modified in various ways that can be understood by those skilled in the art within the scope of the present invention of this application.

This application claims priority based on Japanese Patent Application No. 2017-062115 filed on Mar. 28, 2017, the entire disclosure of which is incorporated herein.

### REFERENCE SIGNS LIST

101, 102 User
201, 211 User terminal
202, 212 Camera device
203, 213 Eyeline detection/user authentication unit
204, 214 Video reproduction application
215, 302 Stream selection unit
301 Video management device
303 Relay unit
401, 402 Video distribution server

1. A video content control system comprising:
a video management device that manages video content distributed from a server; and
a user terminal that displays the video content transmitted from the video management device,
wherein the user terminal comprises:
a first hardware including a processor;
a detection unit, implemented by the first hardware, that detects an eyeline state and a face image of a user;
a user authentication unit, implemented by the first hardware, that performs authentication of the user from the face image detected; and
a detection result transmission unit, implemented by the first hardware, that transmits the eyeline state detected and a result of the authentication to the video management device,
wherein the video management device comprises:
a second hardware including a processor;
a transmission mode selection unit, implemented by the second hardware, that selects a transmission mode of the video content according to the eyeline state and the result of the authentication received; and
a video content transmission unit, implemented by the second hardware, that transmits the video content to the user terminal according to the transmission mode selected, and
the transmission mode selection unit, implemented by the second hardware, of the video management device selects the transmission mode of transmitting the video content so as to suppress a data volume when the user is authenticated and the eyeline state is a state of not looking at the video content displayed on the user terminal.

2. The video content control system according to claim 1,
wherein the transmission mode selection unit selects transmission of only audio of the video content as the transmission mode of transmitting the video content so as to suppress the data volume, and
the video content transmission unit extracts the audio from the video content and transmits the audio to the user terminal.

3. The video content control system according to claim 1,
wherein the transmission mode selection unit selects reduction of a bit rate for transmission to the user terminal as the transmission mode of transmitting the video content so as to suppress the data volume, and
the video content transmission unit reduces the bit rate and transmits the video content to the user terminal.

4. The video content control system according to claim 1,
wherein the detection result transmission unit transmits the eyeline state detected and the result of the authentication to the video management device when the user has been authenticated.

5. The video content control system according to claim 1,
wherein the detection unit detects eyeline states and face images of a plurality of users, and
the transmission mode selection unit selects the transmission mode of transmitting the video content so as to suppress the data volume when some of the users are authenticated and all the eyeline states are states of not looking at the video content displayed on the user terminal.

6.-8. (canceled)

9. A video management device that manages video content distributed from a server, the video management device comprising:
a hardware including a processor;
a transmission mode selection unit, implemented by the hardware, that receives a result of authentication by a face image detected for a user and an eyeline state of the user from a user terminal that displays the video content transmitted from the video management device, and selects a transmission mode of the video content according to the eyeline state and the result of the authentication received; and
a video content transmission unit, implemented by the hardware, that transmits the video content to the user terminal according to the transmission mode selected,
wherein the transmission mode selection unit selects the transmission mode of transmitting the video content so as to suppress a data volume when the user is authenticated and the eyeline state is a state of not looking at the video content displayed on the user terminal.

10. The video management device according to claim 9,
wherein the transmission mode selection unit selects transmission of only audio of the video content as the transmission mode of transmitting the video content so as to suppress the data volume, and
the video content transmission unit extracts the audio from the video content and transmits the audio to the user terminal.

11. The video management device according to claim 9,
wherein the transmission mode selection unit selects reduction of a bit rate for transmission to the user terminal as the transmission mode of transmitting the video content so as to suppress the data volume, and
the video content transmission unit reduces the bit rate and transmits the video content to the user terminal.

12. A user terminal that displays video content transmitted from a distribution server, the user terminal comprising:
a hardware including a processor;
a detection unit, implemented by the hardware, that detects an eyeline state and a face image of a user;
a user authentication unit, implemented by the hardware, that performs authentication of the user from the face image detected;
a transmission mode selection unit, implemented by the hardware, that selects a transmission mode of the video content by the distribution server according to the eyeline state and a result of the authentication; and
a distribution request unit, implemented by the hardware, that requests the distribution server to transmit the video content in the transmission mode,
wherein the transmission mode selection unit selects the transmission mode of transmitting the video content so as to suppress a data volume.

13. The user terminal according to claim 12,
wherein the transmission mode selection unit selects transmission of only audio of the video content as the transmission mode of transmitting the video content so as to suppress the data volume.

14. The user terminal according to claim 12,
wherein the transmission mode selection unit selects reduction of a bit rate for transmission to the user terminal as the transmission mode of transmitting the video content so as to suppress the data volume.

15.-32. (canceled)
